(19) United States
(12) Patent Application Publication
(10) Pub. No.: US 2018/0131104 A1
(43) Pub. Date: May 10, 2018

(54) CONNECTION TERMINAL

(71) Applicant: Yazaki Corporation, Tokyo (JP)

(72) Inventor: Yasuyuki KUDO, Shizuoka (JP)

(73) Assignee: Yazaki Corporation, Tokyo (JP)

(21) Appl. No.: 15/800,208

(22) Filed: Nov. 1, 2017

(30) Foreign Application Priority Data
Nov. 4, 2016 (JP) 2016-216034

(51) Int. Cl. H01R 4/24; H01R 4/18

(52) U.S. Cl. CPC H01R 4/2495; H01R 4/185

(57) ABSTRACT

A connection terminal includes an electric connection part to be connected to a mating terminal, and a wire connection part having a wire barrel to be connected to a terminal part of a covered wire and crimped to a conductor of the covered wire. A chamfer part in which a corner part on the conductor side has been chamfered is provided at least at an end part of the wire barrel in a drawing-out direction of the covered wire.

### BACKGROUND OF THE INVENTION

### Field of the Invention

The present invention relates to a connection terminal, and in particular relates to a connection terminal that has a wire connection part to be crimped to a conductor of a covered wire.

### Description of Related Art

A conventional connection terminal includes a wire connection part that has an electric connection part to be connected to a mating terminal, and a conductor swaging part as a wire barrel to be connected to a terminal part of a covered wire and crimped to a conductor of the covered wire (Japanese Patent-Laid Open No. H11-87010 (Patent Literature 1)).

In the connection terminal, a conductor swaging part is crimped to a conductor exposed by the removal of a covering part of a covered wire with a jig or the like to connect electrically the covered wire with the connection terminal.

At such a conductor swaging part of the connection terminal, a bell-mouth is provided that deforms in a direction in which an end part is separated from a conductor in order to prevent a conductor from being disconnected due to biting of the end part of the conductor swaging part into the conductor when the conductor swaging part is to be crimped to the conductor.

### SUMMARY OF THE INVENTION

In the connection terminal as described in Patent Literature 1, a bell-mouth for preventing disconnection is provided at the end part of a wire barrel, but a corner part of the end part of the wire barrel on a conductor side has an edge-like shape.

Consequently, even if a bell-mouth is formed at a wire barrel when the wire barrel is to be crimped to a conductor, there is a concern that the conductor is injured due to biting or the like of the edge-like corner part into the conductor.

In addition, to the end part of the wire barrel in the drawing-out direction of a covered wire, external forces such as tensile force applied to the covered wire and vibration of the covered wire are applied easily, and therefore, there is also a concern that possibility of disconnection of the conductor becomes very high if injuries are generated in the conductor.

Consequently, the present invention aims at providing a connection terminal capable of preventing a conductor from being injured due to the crimping of a wire barrel to the conductor, and preventing disconnection of the conductor.

A first aspect of the present invention provides a connection terminal including an electric connection part to be connected to a mating terminal; and a wire connection part having a wire barrel to be connected to a terminal part of a covered wire and crimped to a conductor of the covered wire, wherein a chamfer part in which a corner part on the conductor side has been chamfered is provided at least at an end part of the wire barrel in a drawing-out direction of the covered wire.

In the connection terminal, the chamfer part, in which the corner part on the conductor side has been chamfered, is provided at least at the end part of the wire barrel in the drawing-out direction of the covered wire, and therefore, there is no edge-like part at the end part of the wire barrel, which makes it possible to prevent the conductor from being injured in crimping of the wire barrel.

In addition, the chamfer part is provided at least at the end part of the wire barrel in the drawing-out direction of the covered wire, and therefore, the conductor can be prevented from being injured even when tensile force or vibration is generated in the covered wire.

Accordingly, in such a connection terminal, the chamfer part has been provided at the end part of the wire barrel, and therefore, the conductor can be prevented from being injured due to crimping of the wire barrel to the conductor, and the conductor can be prevented from being disconnected.

The conductor of the covered wire of the connection terminal may be formed form a plurality of element wires.

In the connection terminal, the conductor of the covered wire includes a plurality of element wires, and therefore, the chamfer part of the wire barrel can prevent the plurality of element wires from being injured due to crimping of the wire barrel and can prevent the plurality of element wires from being disconnected.

It may be so configured that the wire connection part of the connection terminal has an insulation barrel that swages the covering part of the covered wire and a rubber plug is assembled to the terminal part of the covered wire, and that the insulation barrel swages the outer periphery of the rubber plug to swage the covering part via the rubber plug.

In the connection terminal, the insulation barrel swages the outer periphery of the rubber plug to swage the covering part via the rubber plug, and therefore, injury of the conductor is prevented by the chamfer part and disconnection of the conductor can be prevented, although external force is easily applied to the conductor when tensile force or vibration is applied to the covered wire.

The first aspect of the present invention performs the effect such as being capable of providing a connection terminal that can prevent a conductor from being injured due to crimping of a wire barrel to the conductor and can prevent the conductor from being disconnected.

### BRIEF DESCRIPTION OF THE DRAWINGS

FIG. 1 shows a side view of a connection terminal according to an embodiment of the present invention.

FIG. 2 shows a development view of the connection terminal according to the embodiment of the present invention.

FIG. 3 shows a substantial part enlarged view of FIG. 2.

FIG. 4 shows a cross-sectional view prior to crimping of a wire barrel of the connection terminal according to the embodiment of the present invention to a conductor.

FIG. 5 shows a cross-sectional view when a wire barrel of a connection terminal according to an embodiment of the invention is crimped to a conductor.

### DESCRIPTION OF THE EMBODIMENT

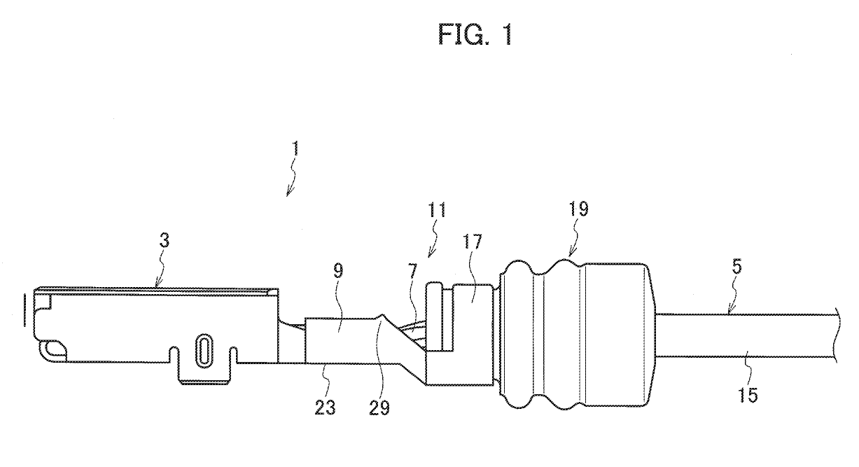

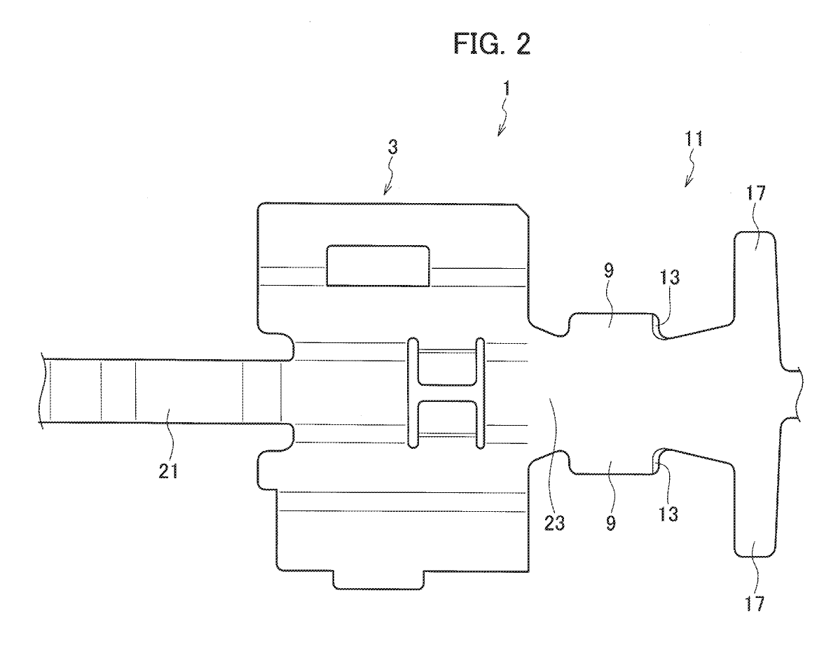

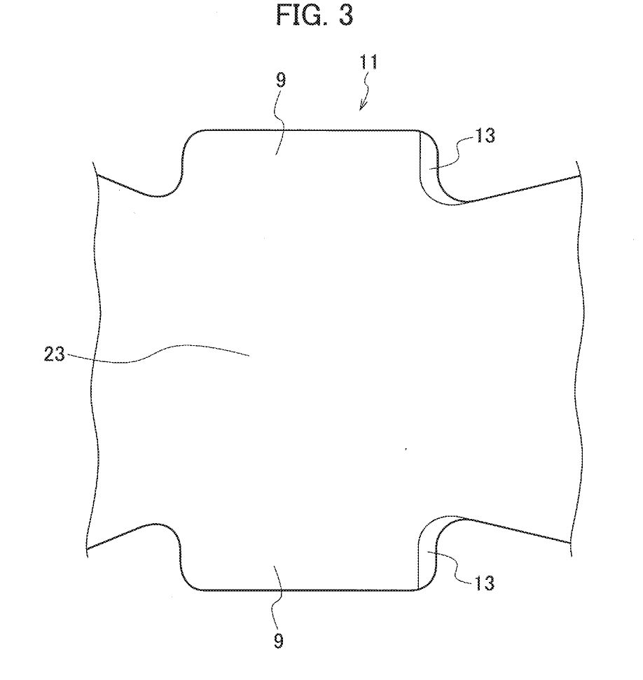

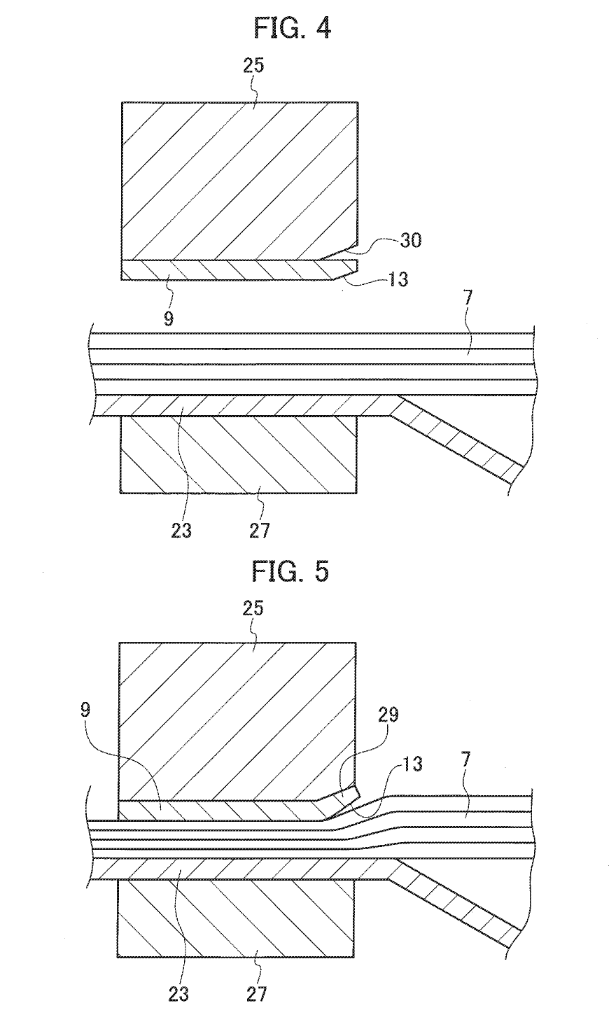

The connection terminal according to an embodiment of the present invention will be described using FIGS. 1 to 5.

A connection terminal 1 according to the embodiment includes an electric connection part 3 to be connected to a mating terminal, and a wire connection part 11 having a wire barrel 9 to be connected to a terminal part of a covered wire 5 and crimped to a conductor 7 of the covered wire 5 and an insulation barrel 17 to be swaged to a rubber plug 19 assembled to a terminal part of the covered wire 5.

Further, at least at the end part of the wire barrel 9 in the drawing-out direction of the covered wire 5, there is provided a chamfer part 13 in which a corner part on the conductor 7 side has been chamfered.

The conductor 7 of the covered wire 5 includes a plurality of element wires.

As shown in FIGS. 1 to 5, the covered wire 5 includes the conductor 7 produced by twisting a plurality of element wires composed of copper-based metal such as copper or copper alloy or aluminum-based metal such as aluminum or aluminum alloy, and a covering part 15 composed of an insulating material that covers the conductor 7.

In the covered wire 5, the covering part 15 at an end portion is peeled off in an intended length and the connection terminal 1 is crimped to the exposed conductor 7.

With respect to the connection terminal 1, press processing or folding processing is given to a plate material composed of copper-based metal such as copper or copper alloy to form the electric connection part 3 and the wire connection part 11.

The electric connection part 3 is subjected to folding processing to be a female box-shape with an elastically deformable elastic piece 21 having a contact part therein.

Into the electric connection part 3, an electric connection part of a male tab-like shape of a mating terminal (not shown) is to be inserted and contacted with the contact part of the elastic piece 21 to connect electrically the connection terminal 1 with the mating terminal.

Such an electric connection part 3 is formed from a member that is continued with the wire connection part 11 via a bottom plate 23.

The wire connection part 11 includes a pair of wire barrels 9 and a pair of insulation barrels 17.

The pair of wire barrels 9 are arranged next to the electric connection part 3 in the drawing-out direction of the covered wire 5 and are formed from each of members continued from both sides of the bottom plate 23, respectively.

The pair of wire barrels 9 is crimped with a jig composed of an upper die 25 and a lower die 27. In the crimping process, the upper die 25 is made to go down toward the lower die 27 in a state where the bottom plate 23 is arranged in the lower die 27 and the conductor 7 is arranged on the bottom plate 23. Consequently, the wire barrel 9 is crimped to the conductor 7 to electrically connect the connection terminal 1 with the covered wire 5.

At this time, at the end parts of the pair of the wire barrels 9 in the drawing-out direction of the covered wire 5, a bell-mouth 29 that prevents the disconnection of the conductor 7 is formed by the upper die 25. In the upper die 25, a chamfer part 30 has been formed in order to form the bell-mouth 29.

The pair of insulation barrels 17 are arranged next to the wire barrel 9 in the drawing-out direction of the covered wire 5 and are formed from each of members continued from both sides of the bottom plate 23, respectively.

Here, to the terminal part of the covered wire 5, the rubber plug 19 is assembled.

When the connection terminal 1 is inserted, for example, into a housing (not shown), the outer periphery face of the rubber plug 19 contacts closely with an inner circumference of an insert hole formed in the housing to make the inside of the housing watertight.

For the terminal part of the covered wire 5 assembled with the rubber plug 19 in this way, the pair of insulation barrels 17 are swaged around the outer periphery of the rubber plug 19 with a jig (not shown) to swage the covering part 15 via the rubber plug 19, and the connection terminal 1 and the covered wire 5 are fixed to each other.

Meanwhile, the pair of insulation barrels 17 may be swaged directly to the covering part 15 of the covered wire 5, not via the rubber plug 19. As the result of swaging the outer periphery of the rubber plug 19 with the pair of insulation barrels 17 as in the Example, the adherence between the rubber plug 19 and the covered wire 5 can be improved, and the waterproof property can be improved.

In such a connection terminal 1, if end parts of the pair of wire barrels 9 in the drawing-out direction of the covered wire 5 are in an edge-like shape, there is a concern that the conductor 7 may be injured when the wire barrel 9 is crimped to the conductor 7.

In particular, external forces such as tensile force applied to the covered wire 5 and vibration of the covered wire 5 are applied easily to the end part of the wire barrel 9 in the drawing-out direction of the covered wire 5, and there is also a concern that the conductor 7 is disconnected with the injury in the conductor 7 as a starting point.

Consequently, there is provided the chamfer part 13 in which the corner part on the conductor 7 side has been chamfered at the end part of the wire barrel 9 in the drawing-out direction of the covered wire 5.

The chamfer part 13 is formed in a tapered shape or an R shape so as to chamfer the corner part on the conductor 7 side from the base end side of the bell-mouth 29 that is formed when the wire barrel 9 is crimped to the conductor 7 toward the leading end in the drawing-out direction of the covered wire 5. Consequently, the bell-mouth 29 is formed so as to expand from the base end side toward the leading end side in the drawing-out direction of the covered wire 5.

As the result of providing the chamfer part 13 at the end part of the wire barrel 9 in this way, the end part of the wire barrel 9 is not formed into an edge-like shape, the end part of the bell-mouth 29 does not bite into the conductor 7 when the wire barrel 9 is crimped to the conductor 7, and injury of the conductor 7 can be prevented.

As the result of providing such a chamfer part 13 at the end part of the wire barrel 9 in the drawing-out direction of the covered wire 5, the conductor 7 is not injured when tensile force, vibration or the like is generated in the covered wire 5 and, therefore, disconnection of the conductor 7 can be prevented.

In addition, no edge-like part exists at the end part of the wire barrel 9 because of the chamfer part 13, and therefore, even when tensile force or vibration is generated in the covered wire 5, injury of the conductor 7 due to interference between the conductor 7 and the end part of the wire barrel 9 can be prevented.

In such a connection terminal 1, there is provided the chamfer part 13 in which the corner part on the conductor 7 side has been chamfered at least at the end part of the wire barrel 9 in the drawing-out direction of the covered wire 5, and therefore, no edge-shaped part exists at the end part of the wire barrel 9 and injury of the conductor 7 in crimping of the wire barrel 9 can be prevented.

In addition, the chamfer part 13 is provided at least at the end part of the wire barrel 9 in the drawing-out direction of the covered wire 5, and therefore, injury of the conductor 7 can be prevented even when tensile force or vibration is generated in the covered wire 5.

Accordingly, in the connection terminal 1 of this kind, the chamfer part 13 is provided at the end part of the wire barrel 9 and, therefore, injury of the conductor 7 due to crimping of the wire barrel 9 to the conductor 7 can be prevented, and disconnection of the conductor 7 can be prevented.

Further, the conductor 7 of the covered wire 5 includes a plurality of element wires, and therefore, the chamfer part 13 of the wire barrel 9 can prevent the plurality of element wires from being injured due to the crimping of the wire barrel 9 and can prevent the plurality of element wires from being disconnected.

Furthermore, the insulation barrel 17 swages the outer periphery of the rubber plug 19 to swage the covering part 15 via the rubber plug 19, and therefore, injury of the conductor 7 is prevented by the chamfer part 13 and disconnection of the conductor 7 can be prevented, although external force is easily applied to the conductor 7 when tensile force or vibration is applied to the covered wire 5.

Meanwhile, in the connection terminal according to the embodiment of the present invention, the chamfer part is provided at the end part of the wire barrel in the drawing-out direction of a covered wire, but, when a conductor is also arranged on the electric connection part side of the wire barrel, a chamfer part may also be provided at the end part of the wire barrel on the electric connection part side.

What is claimed is:

1. A connection terminal comprising:
an electric connection part to be connected to a mating terminal; and
a wire connection part having a wire barrel to be connected to a terminal part of a covered wire and crimped to a conductor of the covered wire,
wherein a chamfer part in which a corner part on the conductor side has been chamfered is provided at least at an end part of the wire barrel in a drawing-out direction of the covered wire.

2. The connection terminal according to claim 1, wherein the conductor of the covered wire is composed of a plurality of element wires.

3. The connection terminal according to claim 1, wherein:
the wire connection part has an insulation barrel that swages a covering part of the covered wire;
a rubber plug is assembled to a terminal part of the covered wire; and
the insulation barrel swages an outer periphery of the rubber plug to swage the covering part via the rubber plug.

4. The connection terminal according to claim 1, wherein a bell-mouth is formed at least at an end part of the wire barrel in a drawing-out direction of the covered wire, when the wire barrel is crimped to the conductor.

5. The connection terminal according to claim 4, wherein the chamfer part is formed in a tapered shape or an R shape so as to chamfer a corner part on the conductor side from a base end side of the bell-mouth toward a leading end in a drawing-out direction of the covered wire.
